(19) United States
(12) Patent Application Publication
(10) Pub. No.: US 2003/0095123 A1
(43) Pub. Date: May 22, 2003

(54) Method and device for control of a display device for a railway control system

(76) Inventor: Werner Hahn, Roetgesbuettel (DE)

Correspondence Address: MORRISON & FOERSTER LLP, 1650 TYSONS BOULEVARD, SUITE 300, MCLEAN, VA, 22102, US

(21) Appl. No.: 10/182,384

(22) PCT Filed: Jan. 16, 2001
(86) PCT No.: PCT/DE01/00235

(30) Foreign Application Priority Data
Jan. 28, 2000 (DE) 100047432

(51) Int. Cl. G06T 11/20

(52) U.S. Cl. 345/440

(57) ABSTRACT

The invention relates to a method of controlling a pixel-oriented display device (5), for a railway control system (10), whereby a representation (AB), of a traffic situation on a railway track installation, is represented on a screen (12) of the display device (5), in such a way that an observer of the screen (12) may recognise the situation and take control measures to influence said situation. The aim of the invention is to carry out such a method particularly cost-effectively, whilst maintaining a high safety standard. Said aim is achieved, whereby the display device (5) has an internal matrix-oriented image memory (15), in which the image data necessary for the display of the representation (AB) is stored, whereby the control of the image device (5), occurs in such a way, that on at least part of the surface of the screen (12), a grid line pattern is displayed, the line width of which is equal to the width of a screen pixel and the grid line separation of which corresponds to a non-linear multiple of the individual pixel separation.

This is a national stage of PCT/DE01/00235 filed Jan. 16, 2001 which is based on German application 100 04 743.2 filed Jan. 28, 2000.

### TECHNICAL FIELD OF THE INVENTION

The invention relates to a system and method for displaying an image of a traffic situation in a railroad track system on a display screen.

### BACKGROUND OF THE INVENTION

A method of displaying an image of a traffic situation is disclosed in the publication “Verfahrensgesicherte Meldebildanzeige für den Fdl-Arbeitsplatz bei der Deutschen Bahn AG” [“Methodologically reliable signalling display for the Fdl workstation in the Deutsche Bahn AG”] (Horst Forstreuter and Achim Weitnervon Pein, Signal+Draht 86, 1994, volume 10, pages 320 to 324). This known method is a driving method for a high-resolution, pixel-oriented visual display unit that belongs to a railroad control system. Within the scope of the known method, an image of a traffic situation on a railroad track system is represented on a display screen of the visual display unit such that a viewer or an operator of the railroad control system can identify and understand the traffic situation and can take control measures and operational actions to influence the traffic situation.

### SUMMARY OF THE INVENTION

The invention discloses a system and method of displaying an image of a traffic situation in a railroad track system on a display screen in a particularly cost-effective fashion while a high safety standard is maintained.

In one embodiment of the invention, use is made of a visual display unit which has an internal, matrix-oriented image memory in which the image data required for displaying the image are stored, the visual display unit being driven such that it displays on at least one area of the display screen a gridline pattern, whose gridline width corresponds to the width of a display screen pixel, and whose gridline spacing corresponds to an odd multiple of the individual pixel spacing.

One advantage of the invention is that it can be carried out in a particularly cost-effective fashion, since use is made of a visual display unit with an internal, matrix-oriented image memory. Such visual display units—such as, for example, most designs of LCD (Liquid Crystal Display) display screens or visual display units, in particular those having TFT technology—can be acquired very cost-effectively nowadays because of their wide use in the so-called consumer field. It is known that very high safety standards are prescribed in the field of railroad traffic technology.

In order to be able to reach these safety standards, it is to be ensured that a defective image cannot even appear on the display screen, or else can be identified immediately as false for the user or for the operator of the railroad control system. In the known method, this is achieved essentially by virtue of the fact that visual display units lacking image memories such as standard monitors with cathode-ray tube are used. Consequently, the image of the traffic situation is stored in the known method exclusively in the control device (PC or DP system) driving the visual display unit—in concrete terms, in the graphics card—such that it is directly possible at any time to read out or read back the image memory in order to monitor the image content.

By contrast herewith, in one embodiment of the invention it is, impossible, or not immediately possible, to read back the image information from the internal image memory of the visual display unit, specifically because the present-day customary interfaces between control device (computer) and visual display unit do not permit any “reading back” of image information. That is, the interfaces operate in terms of one direction. In one embodiment of the invention, the visual display unit is driven such that it displays on at least one subarea of the display screen a gridline pattern whose gridline width corresponds to the width of a display screen pixel, and whose gridline spacing corresponds to an odd multiple of the individual pixel spacing. On the basis of this display of the gridline pattern, an operator of the railroad control system can immediately identify display errors that are generally difficult to find, or cannot be found at all, as is now to be explained.

In the case of an image with an image resolution of 1280×1024 pixels (that is, an image matrix with 1280 rows and 1024 columns), a row address with 11 bits and a column address with 10 bits are required given a coding of the row and column numbering in the dual number format. If, in this case, one of the row or column bits is defective, for example such that the column bit continuously exhibits a logic “1” or a logic “0”, the result is deviations between the image actually represented on the display screen and the image actually desired. In this case, on the basis of the binary coding the effects of the bit errors are entirely different depending on their bit position in the binary-coded row and column addresses, as is now to be explained below with the aid of the column coding.

The dual coding of the column numbering leads, when described graphically, to the fact that the most significant bit (bit position n) establishes whether the respective pixel is to lie in the left or right half of the image. The bit next lower in significance (bit position n−1) then specifies whether the respective pixel is to lie in the right or left quarter of the image of the half of the image established by the most significant bit. In a corresponding way, the remaining bits then establish which column is selected, the least significant bit establishing whether the left or the right column of the pair of columns established by the remaining bits is selected. The applicant has established, by simulating the image falsifications produced by bit errors, that bit errors in the least significant address bit of the binary address coding are particularly grave, since in the case of these errors the missing pixel rows and pixel columns never lie next to one another, and so no planar representational errors are produced, and therefore on occasion the representational errors can be detected on the display screen with difficulty. Because of the way a gridline pattern with the abovementioned features is displayed according to the invention, however, such errors mostly become clearly visible, since in the event of an error in the least significant bit such a gridline pattern can no longer be correctly represented. Specifically, if the least significant bit is always logic “1” or always logic “0”, each second row or column can no longer be addressed and is therefore no longer “describable”, and this leads to a clearly detectable optical change in the gridline pattern.

In summary, the invention is, cost-effective because of the use of visual display units, which are particularly cost-effective nowadays. And, the invention is also suitable for very high safety requirements on the basis of the representation of the gridline pattern. Specifically, in concrete terms the safety problem, associated with the internal image memory, that it is impossible to read back image contents as in the case of the previously known method is overcome very simply by the additional representation of the gridline pattern. Another advantage of the invention is that the visual display units with internal image memory that are used here—LCD display screens or visual display units, for example, as already set forth above —generally operate without radiation or with very low radiation, and so the invention also meets the highest requirements placed on the industrial safety for operating staff. In addition, it may be pointed out that LCD display screens also have the advantage that they are very insensitive to electromagnetic interfering radiation, and are therefore distinguished by a very high electromagnetic strength.

It is also advantageous within the scope of the embodiments of the invention, if the image is represented on the display screen against a display screen background whose brightness or color is set differently in the presence of the control signal than in the absence of this control signal. Within the scope of the embodiments of the invention, in addition to the imaging errors caused by the least significant bit, it is also possible to detect errors that are based on the remaining address bits, in particular the most significant bit, or on the more significant bits. As already set forth above in detail, the most significant bit establishes which half of the display screen is selected. If an error now occurs in the case of this most significant bit, for example an error such that the bit always has a logic “0”, new image information would no longer be displayed on one side of the display screen in the case of defective column coding, or on the upper or lower half of the display screen in the case of defective row coding, but still the “old” image information. The image of the traffic situation would thereby be partially “frozen” and no longer correct.

This would not be immediately detectable here for the viewer of the display screen because he cannot know whether a changed traffic situation has come about. In order also to visualize clearly such errors with reference to more significant bits or to the most significant bit, according to the invention the brightness or color of the display screen background is modified whenever a corresponding control signal is present. This control signal is to be formed when it is to be checked whether the display on the display screen is correct. If, given the presence of the control signal, the desired whole-area change in the display screen background then comes about it is thus ensured that the address bits, in particular the most significant address bit, and also the remaining more significant address bits of the image memory operate correctly. If, however, streaking comes about on the display screen background, the reason for this is that one of the address bits has not been switched over. This streaking can generally be detected very easily on the display screen.

In the field of railroad engineering, it is preferable to ensure that the display on the display screen is correct when the traffic situation is influenced by user-end control measures. In railroad control systems, a control measure is typically performed in two stages —as may be gathered, for example, from the publication mentioned at the beginning. In this case, the operator of the railroad control system generates an actuating signal that identifies the respective control measure. Subsequently, the control measure is signaled by a corresponding change in the image of the traffic situation on the display screen, as a result of which the operator is prompted to generate an acknowledgement signal confirming the control measure. Not until after the acknowledgement signal is present is the control measure then realized on the part of the control system or of the signal box. The period after input of the actuating signal and before output of the acknowledgement signal is therefore particularly critical, and so it is preferable in this period to place particularly high importance on a correct representation of the image of the traffic situation. According to one embodiment of the invention, the control signal is therefore generated during this period. That is, the change in the display screen background is also provided according to the invention during this period.

The invention also discloses a control device for driving a visual display unit with the aid of which device images of traffic situations on railroad track systems can be represented in a particularly cost-effective fashion while retaining a high safety standard.

In one embodiment of the invention, a control device for a railroad control system for influencing a traffic situation on a railroad track system, and for driving a pixel-oriented visual display unit such that the unit displays an image of the traffic situation, in which case the control device is designed such that it drives the visual display unit such that the unit displays on at least one subarea of the display screen a gridline pattern whose gridline width corresponds to the width of a display screen pixel, and whose gridline spacing corresponds to an odd multiple of the individual pixel spacing.

In the above explanations, mention has been made of an operator who is to identify a representational error in the gridline pattern or in the display screen background. However, an imaging error can also be detected by machine, for example by picking up the image on the display screen with the aid of a video camera and subsequently subjecting it in a computer to an automated image identification method. In the course of this image identification method, the gridline pattern represented, or the display screen background shown is then compared with a stored (correct) gridline pattern or display screen background, and an alarm signal is generated in the case of a deviation between the stored and represented gridline patterns or display screen backgrounds.

### BRIEF DESCRIPTION OF THE DRAWINGS

In order to explain the invention,

FIG. 1 shows an exemplary embodiment of an arrangement for carrying out the invention.

FIG. 2 shows a gridline pattern in a “pixel representation” for the exemplary embodiment in accordance with FIG. 1.

FIG. 3 shows the gridline pattern in accordance with FIG. 2.

FIGS. 4a and 4b show representations, falsified by address bit errors, of the gridline pattern in accordance with FIG. 3.

FIGS. 5a to 5e show display screen backgrounds with and without address bit errors.

### DETAILED DESCRIPTION OF THE PREFERRED EMBODIMENTS

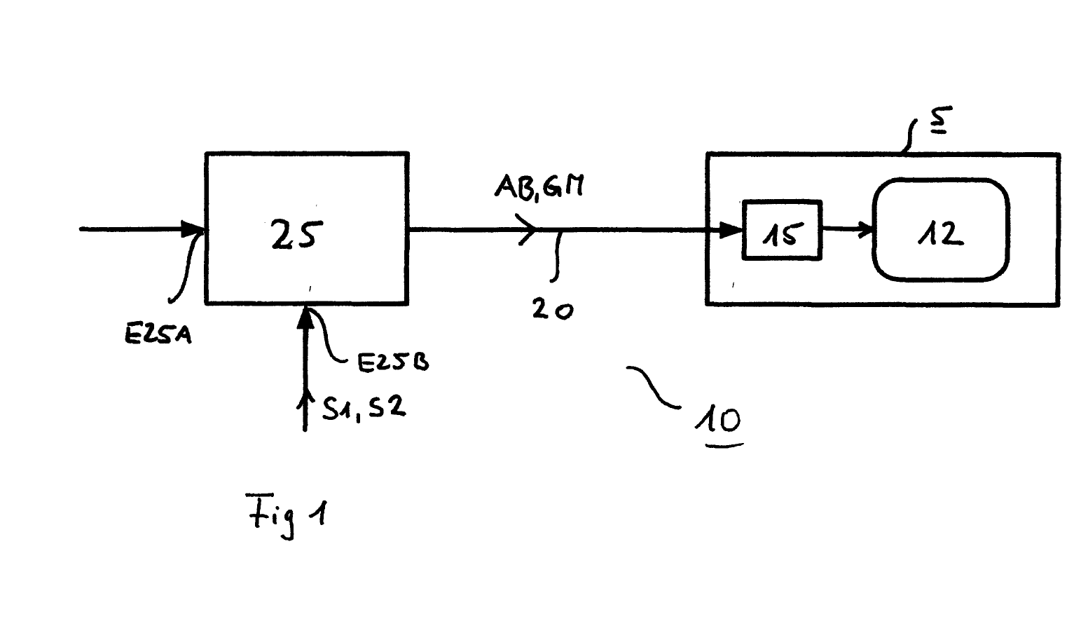

FIG. 1 shows a pixel-oriented visual display unit 5 of a railroad control system 10. The visual display unit 5 can be, for example, an LCD visual display unit, in particular one employing TFT technology, or a PLASMA visual display unit. The visual display unit 5 of the railroad control system 10 represents an image AB of a traffic situation on a railroad track system (not shown in FIG. 1), such that a viewer of the display screen 12 of the visual display unit 5, or an operator of the railroad control system 10 can identify the traffic situation and take control measures to influence it. On the input side, the visual display unit 5 has an internal, matrix-oriented image memory 15 in which the image data required for representing the image on the display screen 12 are filed or stored.

The image memory 15 is connected via an interface 20 to a control device 25 that can be formed, for example, by a PC or a DP system or a microprocessor arrangement. This control device 25 is connected with one of its inputs E25A to sensors (not shown in FIG. 1), that transmit the “traffic” or “situation” data required for representing the image of the traffic situation to the control device 25. With its other input E25B, the control device 25 is connected to operating devices (not shown in FIG. 1), with the aid of which the operator of the railroad control system 10 can generate actuating signals S1 or acknowledgement signals S2 for influencing the traffic situation, and feed them into the control device 25. The control device 25 has control outputs (not illustrated in FIG. 1) at which it relays the operator-end measures for influencing the traffic situation—established by the actuating signals S1 and/or acknowledgement signals S2—as appropriate output control signals to control elements (signals, points, brakes, conveyor systems, etc.) of the railroad track system.

In this case, the control device 25, which, as already stated above, can be formed by a microprocessor arrangement, is configured or programmed by an appropriate control program such that, in addition to the image of the traffic situation, it produces a gridline pattern GM and relays it to the visual display unit 5 for the purpose of display on the display screen 12.

The gridline pattern is displayed in this case on a subarea of the display screen 12 that is not required for the representation of the image of the traffic situation, that is to say in the region of one of the margins of the display screen, in general.

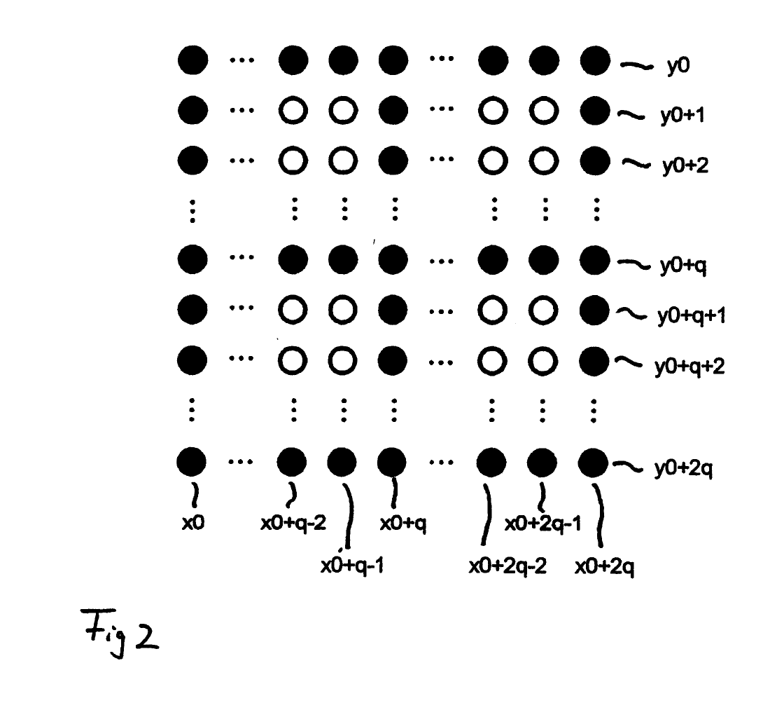

An exemplary embodiment of a gridline pattern is shown in FIG. 2. This gridline pattern occupies a pixel region that is formed by the pixels with column numbers between x0 and x+2q, and with row numbers between y0 and y0+2q. X0 and y0 denote the coordinates of the left upper corner of the gridline pattern. The variable q in this case specifies the spacing between the gridlines of the gridline pattern, and is intended to be an odd number, for example, it can be that q=“3”.

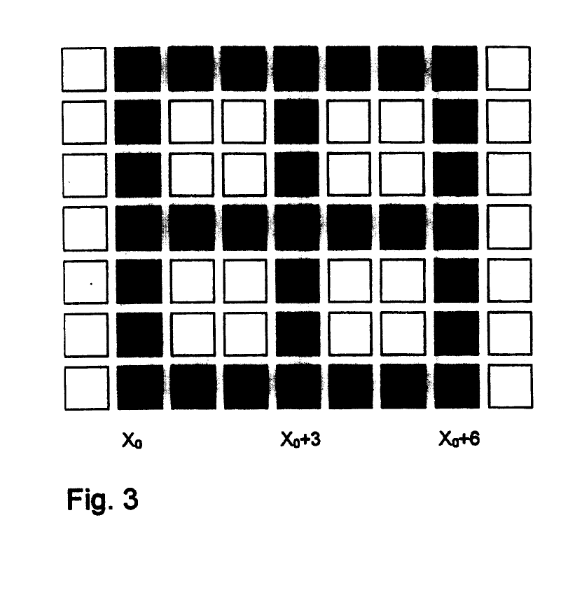

FIG. 3 shows the gridline pattern in accordance with FIG. 2 once again graphically for the case q=3 in the error-free instance. That is, for the case in which the image memory 15 works correctly and correctly reproduces the gridline pattern produced by the control device 25. As may be seen in FIGS. 2 and 3, the gridline width corresponds to the width of a display screen pixel.

Below is an explanation of representational errors which occur when the memory cells of the image memory 15 can no longer be correctly addressed. In this case, for example, it is assumed that the least significant address bit A(0) of the column address is no longer working properly and is permanently “0” or “1” (A(0)=0 and A(0)=1). In this case, the corresponding image memory cells, whose least significant address bit A(0) =0 or A(0)=1, necessarily include that content which had last—that is to say on the occasion of the last writing operation in time—been assigned to them before failure of the address bit A(0). With reference to the content of the faulty cells, it is assumed as a starting point that the image memory 15 initially works correctly, and so the gridline pattern in accordance with FIG. 2 or 3 is originally correctly represented, and the defect in the image memory occurs subsequently. The “frozen” content of the faulty cells can therefore be read out respectively in FIG. 3 for the two cases of error investigated below:

1st Case of Error

The first to be investigated is the case in which the least significant address bit A(0) of the column address is permanently at “0” (A(0)=0). In this case, the columns with an odd column number can no longer be addressed, and therefore remain frozen. By contrast with this, the even columns are addressed twice. Specifically, the correct image information is written into an image cell with an even column number. Subsequently, when the respective next column with an odd column number is actually to be addressed, the addressing error then occurs because the address bit A(0) cannot be switched over from “0” to “1”. This has the effect that the image information that was actually intended for the next column is written once again into the column with the even column number. The correct image content of this column is then written over, specifically with the image information that was intended for the next column with the odd column number.

Thus, when investigating the 1st case of error, the assumption is made that the columns are addressed successively one after another in the direction of rising column numbers. In the case of quick memory writing or of quick display building, it is exclusively the false image content that comes to bear optically for all columns with an even column number.

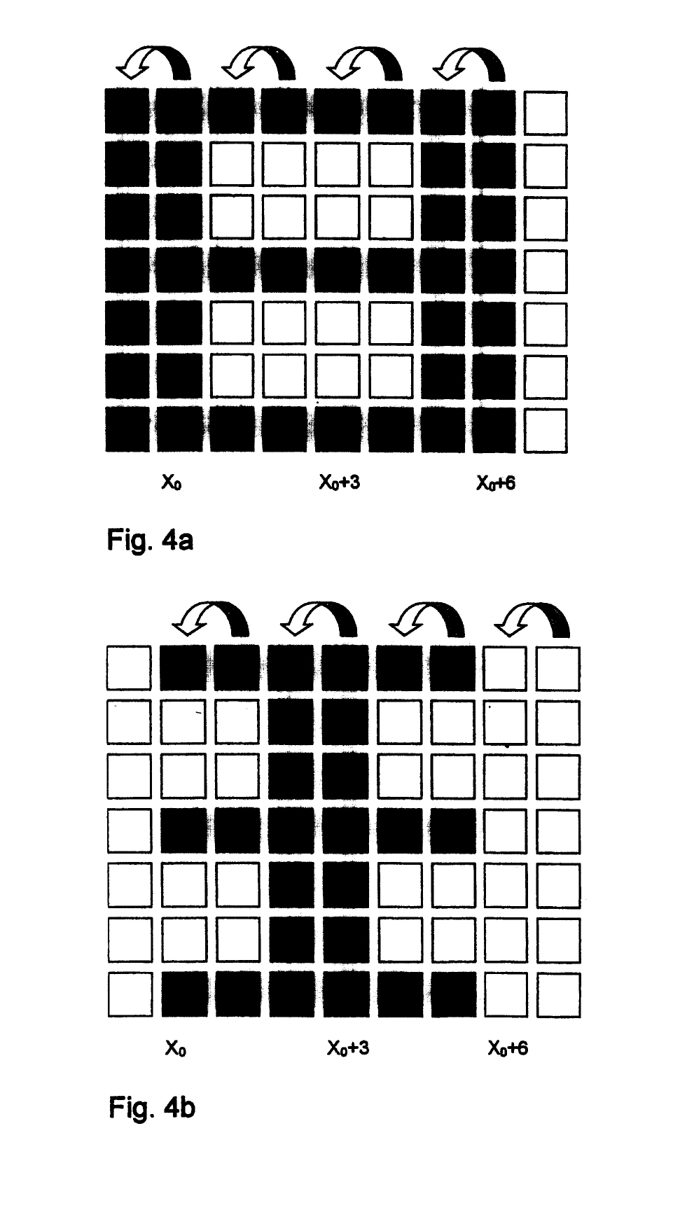

FIG. 4a shows the pattern arising in the 1st error case for the case in which the column number x0 of the image memory cell of the left upper corner point of the gridline pattern is odd. FIG. 4b shows the resulting pattern for the case in which the column number x0 is even.

2nd Case of Error

The aim now is to investigate the case in which the least significant address bit A(0) is permanently at “1” (A(0)=1). In the 2nd case of error, the columns with even column numbers are therefore “frozen”, and the odd columns are addressed twice. The addressing error therefore becomes visible whenever the address bit A(0) is to be switched over from “1” to “0”. Since this is not done because of the address bit error, what happens in the attempt to describe a column with an even column number is that the respective next column with an odd column number is addressed, and the image information is written into this. Subsequently, when it is the turn of this next column with an odd column number, this false image content is, however, overwritten with the correct image content. Depending on the speed of the writing process or the display building, the 2nd case of error is difficult or, possibly, even impossible to detect, since the occurrence of the false gridline pattern is very short.

In order also to be able to detect the 2nd case of error reliably and to be able to visualize bit errors in other positions of the binary address coding, it is additionally provided in the arrangement in accordance with FIG. 1 that the display screen background is changed with reference to its color or brightness whenever the operator of the railroad control system 10 undertakes control measures for influencing the traffic situation on the railroad track system. As already explained above, a control measure is mostly performed in two stages in the field of railroad technology: in the first stage, the operator inputs an actuating signal S1 that specifies the type of control measure. If, for example, the aim is to set a signal XY (to proceed position or to proceed indication), the operator thus generates the actuating signal S1 with the information “set signal XY to proceed”. After inputting of the actuating signal S1, the railroad control system 10 then displays the railroad track system with an appropriately marked signal, the operator thus being shown clearly which actuating signal he has generated. If the display corresponds to what the operator wanted as a control measure, he generates an acknowledgement signal S2 with the aid of which the actuating signal is confirmed in terms of content, and the corresponding command “set signal XY to proceed” is brought to execution by the control device 25. In the period between the inputting of the actuating signal S1 and the inputting of the acknowledgement signal S2, it is therefore preferable to ensure that the image displayed on the display screen 12 corresponds to that which was produced as an image by the control device 25.

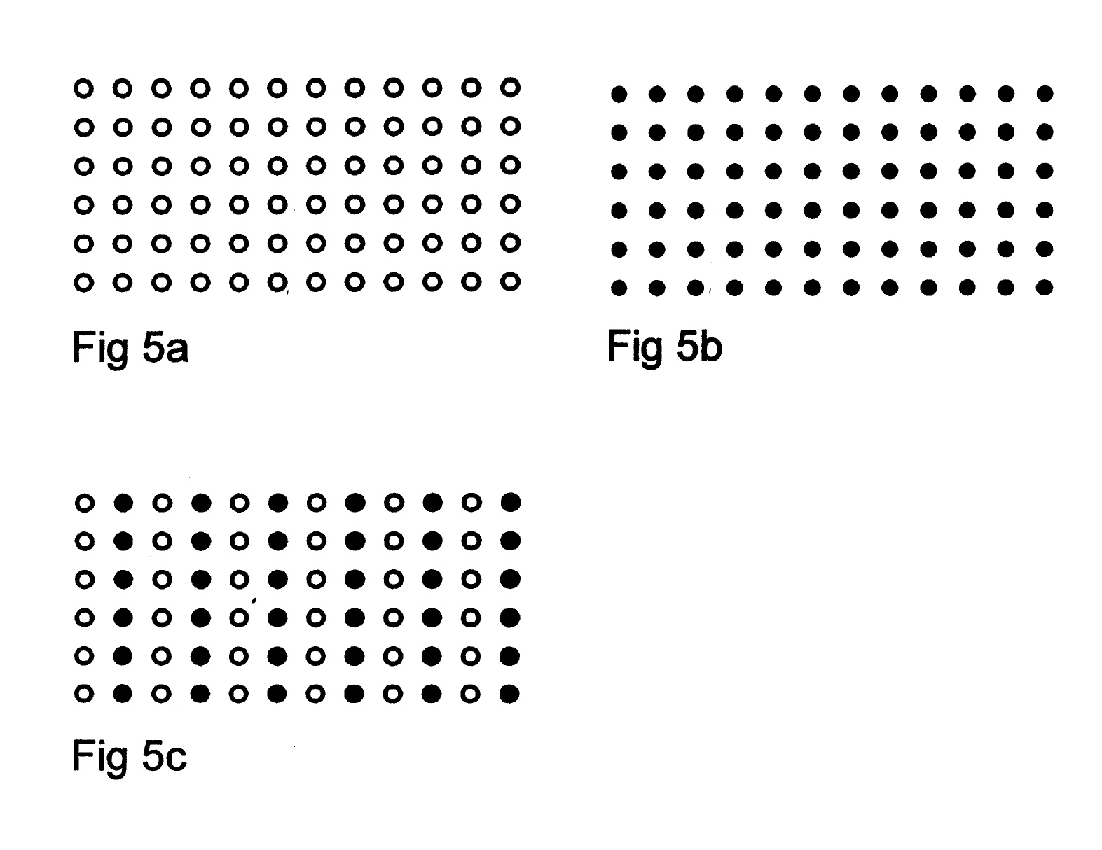

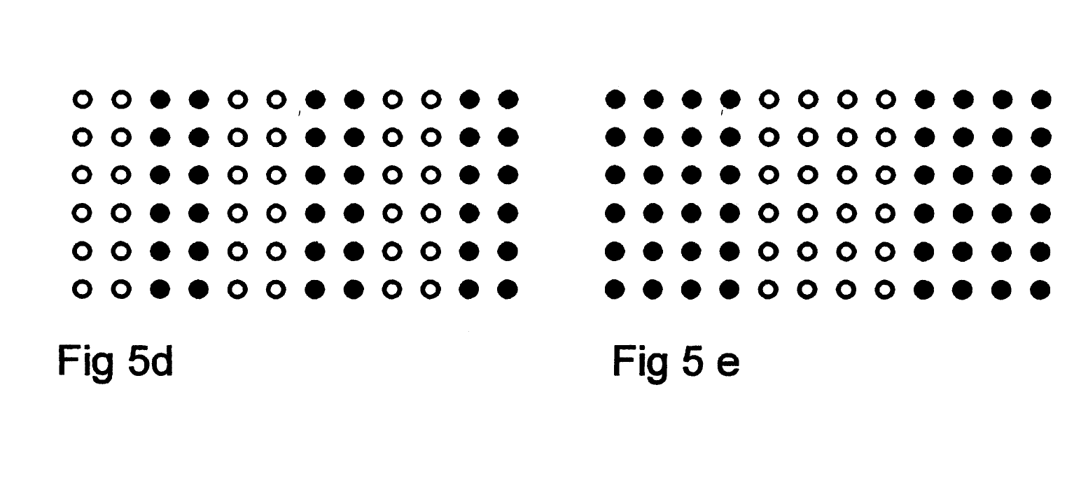

In order to achieve this, after inputting the actuating signal S1 a control signal is generated in the control device 25 that is not erased or withdrawn by the control device 25 until the acknowledgement signal S2 is present. In the period in which the control signal is present, the display screen background—on which the image of the traffic situation is represented—is changed over the entire area, or at least a very large area, for example in color or in brightness. This is illustrated in FIGS. 5a and 5b. In this case, FIG. 5a shows the display screen background in pixel representation in its original form—that is to say before the change—and FIG. 5b shows it thereafter, that is to say after the modification. For technical printing reasons, the change was represented in this case such that the previously white pixels are subsequently black. The modification of the display screen background with reference to a change in color or brightness should be such that the image of the traffic situation can be identified clearly both before and after the modification. For example, a change in brightness from a bright gray background to a dark gray background would be possible.

FIG. 5c illustrates the display screen background when the least significant bit A(0) of the column address—called first bit A(0) below—is disturbed. Specifically, streaking with a streak width of one pixel is to be seen in FIG. 5c.

FIG. 5d shows the display screen background when the bit A(1) of the column address that is next higher in significance with reference to the least significant bit A(0)—termed second bit A(1) below—is disturbed. Streaking with a streak width of two pixels is to be seen in FIG. 5d.

FIG. 5e shows the display screen background when the bit A(2) next higher in significance with reference to the second bit A(1)—termed third bit A(2) below—is disturbed: the streak width is four pixels.

Corresponding display screen backgrounds result for more significant bit errors. That is, the streak width is greater the higher the “rank” of the bit. In the case of the ith bit, the column width would be 2ⁱ⁻¹ pixels.

The representation of the gridline pattern can be limited to the period in which the control signal is present. The gridline pattern would then not be produced until after input of an actuating signal, in each case. The gridline pattern should preferably be displayed on a display screen area in which otherwise the display screen background is visible. This configuration of the gridline pattern representation offers the advantage that the above-described 2nd case of error can also be detected immediately at the operator end: an addressing error is present if the gridline pattern is not correctly constructed.

1. A method for displaying an image (AB) of a traffic situation in a railroad track system on a display screen (12) of a pixel-oriented visual display unit (5), driven by a control device (25), of a railroad control system (10),
the traffic situation being represented in the case of the method in such a way that a viewer of the display screen (12) can identify the traffic situation and take control measures to influence it, characterized in that use is made as visual display unit of a visual display unit (5) which has an internal, matrix-oriented image memory (15) in which the image data required for displaying the image (AB) are stored,
the visual display unit (5) being driven in such a way that it displays on at least one subarea of the display screen (12) a gridline pattern,
whose gridline width corresponds to the width of a display screen pixel, and
whose gridline spacing corresponds to an odd multiple of the individual pixel spacing.

2. The method as claimed in claim 1, characterized in that
the image (AB) is represented on the display screen (12) against a display screen background whose brightness or color is set differently in the presence of a control signal than in the absence of this control signal.

3. The method as claimed in claim 2, characterized in that
the control signal is formed by the control device (25) automatically in a period between the input of a user-end actuating signal (S1) and the input of a user-end acknowledgment signal (S2).

4. A control device for a railroad control system
for influencing a traffic situation on a railroad track system, and
for driving a pixel-oriented visual display unit (5) in such a way that the latter displays an image (AB) of the traffic situation, characterized in that
the control device (25) is designed in such a way that it drives the visual display unit (5) in such a way that the latter displays on at least one subarea of the display screen (12) a gridline pattern
whose gridline width corresponds to the width of a display screen pixel, and
whose gridline spacing corresponds to an odd multiple of the individual pixel spacing.

5. The control device as claimed in claim 4, characterized in that
the control device (25) is designed in such a way that the image (AB) is represented on the display screen (12) against a display screen background whose brightness or color is different in the presence of a control signal than in the absence of this control signal.

6. The control device as claimed in claim 5, characterized in that
the control device (25) is designed in such a way that it forms the control signal automatically in a period between the input of a user-end actuating signal (S1) and the input of a user-end acknowledgement signal (S2).
